(19) United States
(12) Patent Application Publication
(10) Pub. No.: US 2015/0213498 A1
(43) Pub. Date: Jul. 30, 2015

(54) METHOD AND APPARATUS FOR PROVIDING PRODUCT INFORMATION

(71) Applicant: FUJITSU LIMITED, Kawasaki-shi (JP)

(72) Inventor: Fumito Ito, Kita (JP)

(21) Appl. No.: 14/592,064

(22) Filed: Jan. 8, 2015

(30) Foreign Application Priority Data
Jan. 29, 2014 (JP) 2014-014141

(51) Int. Cl. G06Q 30/02

(52) U.S. Cl. CPC G06Q 30/0261; G06Q 30/0251

(57) ABSTRACT

An information processing apparatus extracts, on the basis of information indicating a plurality of products attracting the interest of a customer and registered information in which data values are registered in a plurality of data items on the products, data items each having different data values between the plurality of products. The information processing apparatus outputs the data values registered in the extracted data items, as comparison information. This makes it possible to identify information useful for the customer to select a product.

### CROSS-REFERENCE TO RELATED APPLICATION

This application is based upon and claims the benefit of priority of the prior Japanese Patent Application No. 2014-014141, filed on Jan. 29, 2014, the entire contents of which are incorporated herein by reference.

### FIELD

The embodiments discussed herein are related to a product information providing method and a product information providing apparatus.

### BACKGROUND

In recent years, there has been attention to techniques for identifying and displaying products that attract the interests of customers in a store. Such techniques enable a store clerk to view a screen that displays products attracting the interest of a customer and provide the customer with information on the products, for example.

Examples of the techniques are described below. For instance, there has been proposed a system in which products attracting the interest of a customer are identified based on images captured by a camera, and information on the identified products is displayed on a display device. There has also been proposed a system in which, if two different product IDs (identification) are acquired from an IC (Integrated Circuit) reader or the like successively within a specific period of time, information on the products corresponding to both of these acquired product IDs is extracted and displayed for comparison.

Please see, for example, Japanese Laid-open Patent Publication No. 2009-3701 and Japanese Laid-open Patent Publication No. 2010-231424.

However, the foregoing techniques are used merely to display information on products attracting the interest of a customer or display information on a plurality of products for comparison. Therefore, these techniques are not necessarily capable of identifying information useful for the customer to select a product.

### SUMMARY

According to one aspect, there is provided a product information providing method including: extracting, by a computer, based on information indicating a plurality of products and registered information in which data values are registered in a plurality of data items for each of the plurality of products, a data item having possibly different data values between the plurality of products; and outputting, by the computer, the data values registered in the extracted data item.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a process by an information processing apparatus according to a first embodiment;

FIG. 2 illustrates an example of a product information providing system according to a second embodiment;

FIG. 3 illustrates an example of placement of a sensor device;

FIG. 4 illustrates an example of a hardware configuration of the sensor device;

FIG. 5 illustrates an example of a hardware configuration of a product information providing apparatus;

FIG. 6 illustrates an example of a hardware configuration of a terminal device;

FIG. 7 illustrates an example of how to determine a product viewed by a customer;

FIG. 8 illustrates an example of how to determine a product viewed by a customer (continued from FIG. 7);

FIG. 9 illustrates an example of functions of the sensor device, the product information providing apparatus, and the terminal device;

FIG. 10 illustrates an example of skeletal information;

FIG. 11 illustrates an example of a store shelf information table;

FIG. 12 illustrates an example of an area information table;

FIG. 13 illustrates an example of a product information table;

FIG. 14 illustrates an example of a customer information table;

FIG. 15 illustrates an example of a viewed product information table;

FIG. 16 illustrates an example of contents of comparison information and display of the same;

FIGS. 17 and 18 are a flowchart of an example of a process for updating viewed product information;

FIG. 19 is a flowchart of an example of a process for generating and transmitting comparison information;

FIG. 20 illustrates a modification of the contents of comparison information and display of the same;

FIG. 21 is a flowchart of a modification of a process for generating and transmitting comparison information; and

FIG. 22 illustrates a modification of a method for identifying a most-viewed product.

### DESCRIPTION OF EMBODIMENTS

Several embodiments will be described below with reference to the accompanying drawings, wherein like reference numerals refer to like elements throughout.

### First Embodiment

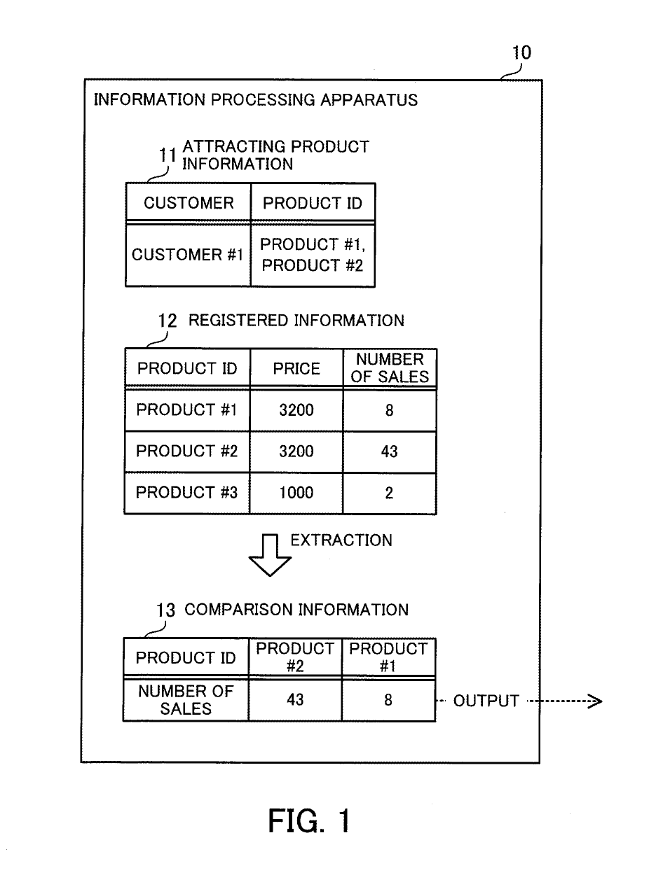

FIG. 1 illustrates an example of a process by an information processing apparatus according to a first embodiment. An information processing apparatus 10 is realized by using a computer or the like, for example. The information processing apparatus 10 is installed at a predetermined place in a store where products are sold, for example.

On the basis of on attracting product information 11 indicating a plurality of products attracting the interest of a customer and registered information 12 in which data values are registered in a plurality of data items for each of the products, the information processing apparatus 10 extracts data items each having different data values between the plurality of products attracting the interest of the customer. The attracting product information 11 and the registered information 12 may be stored in a storage device included in the information processing apparatus 10 or may be acquired from another device or a storage medium.

Products attracting the interest of the customer are determined based on results of monitoring the customer's actions by the use of various sensors around an area where products are arranged in the store, for example. The products attracting the interest of the customer may be determined by analyzing images of the customer captured by an imaging device, for example. In the case where it is recognized from the captured images that the customer picked up a product or stopped in front of the product, for instance, the product is determined as attracting the interest of the customer.

In another example, products attracting the interest of the customer may be determined based on information read by a non-contact IC reader held by the customer from IC tags attached to the products. Alternatively, products attracting the interest of the customer may be determined based on information read by a barcode reader held by the customer from barcodes attached to the products.

The attracting product information 11 contains information on a plurality of products in the store determined as attracting the interest of the customer according to the method as described above. For example, as illustrated in FIG. 1, the attracting product information 11 contains the product IDs of products determined as attracting the interest of the customer. The information processing apparatus 10 acquires the attracting product information 11 when a store clerk has performed an input operation or at another time, for instance. Alternatively, the information processing apparatus 10 itself may determine products attracting the interest of the customer.

The registered information 12 includes different kinds of product information as a plurality of data items. For example, the registered information 12 illustrated in FIG. 1 includes the following data items: price of product and the number of sales.

As illustrated in FIG. 1, the registered information 12 indicates the prices and the numbers of sales with respect to products #1, #2, and #3. In addition, the attracting product information 11 indicating that customer #1 has interest in the products #1 and #2 is acquired.

In this case, the information processing apparatus 10 extracts, from the registered information 12, the number of sales as a data item having different data values between the products #1 and #2.

The information processing apparatus 10 outputs the data values registered in the extracted data item. The data values registered in the extracted data item are output as comparison information 13. In the foregoing example, the information processing apparatus 10 generates and outputs the comparison information 13 including the data values registered in the extracted data item of the number of sales.

The comparison information 13 may be output to a terminal device held by a store clerk, for example. In this case, the terminal device displays the comparison information 13 received from the information processing apparatus 10, for instance. The store clerk holding the terminal device is able to refer to the contents displayed on the terminal device and provide the customer with information on the data item having different data values out of the information on the products attracting the interest of the customer.

In addition, the information processing apparatus 10 may display the comparison information 13 and other information on the display included in the information processing apparatus 10. In this case, for example, the store clerk at a cash register or a service counter is able to refer to the displayed comparison information 13 and other information and recognize the information on the data item with different data values registered out of the information on the products attracting the interest of the customer.

In selecting a product, the customer takes notice of different features of products in which he/she has interest (for example, the prices or forms of products). Therefore there is a high possibility that information useful for the customer to select a product is specific kinds of information having different contents among the products, out of various kinds of information on the products attracting his/her interest. However, according to a technique merely for listing and displaying information on products attracting the interest of a customer, a user is unable to easily identify information useful for a customer as described above.

In contrast, the information processing apparatus 10 in the first embodiment extracts a data item (the number of sales) having different data values and output the data values of the extracted data item (“8” and “43”), on the basis of the attracting product information 11 indicating the products #1 and #2 that attract the interest of the customer and the registered information 12 in which data values are registered in a plurality of data items for each of the products #1 and #2. Accordingly, it is possible to identify information useful for the customer to select a product.

### Second Embodiment

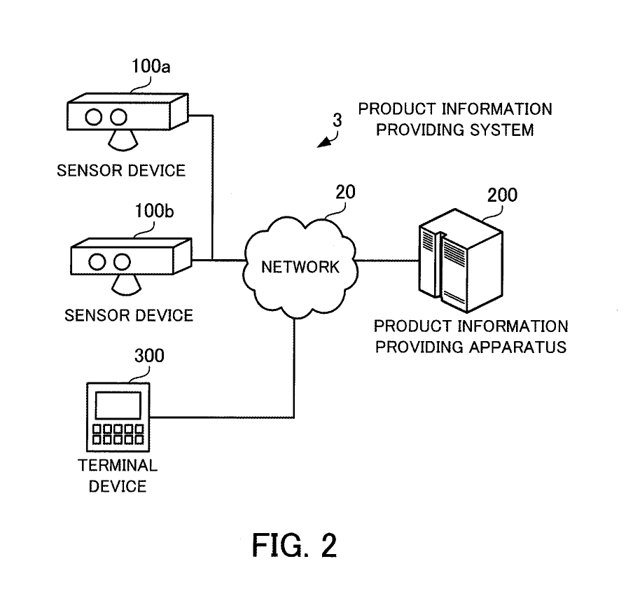

FIG. 2 illustrates an example of a product information providing system according to a second embodiment. A product information providing system 3 has sensor devices 100a and 100b, a product information providing apparatus 200, and a terminal device 300. Any number of sensor devices may be provided. The product information providing apparatus 200 is connected via a network 20 to the sensor devices 100a and 100b and the terminal device 300. The sensor devices 100a and 100b and the product information providing apparatus 200 are disposed in a store where products are sold. Alternatively, only the sensor devices 100a and 100b may be disposed in the store and the product information providing apparatus 200 may be placed outside of the store. The product information providing apparatus 200 is an example of the information processing apparatus 10 of the first embodiment.

The sensor devices 100a and 100b have a function of capturing images. The sensor devices 100a and 100b capture images of at least an area where products are arranged in the store. For example, the sensor devices 100a and 100b capture images of an area where products are arranged on a store shelf.

The sensor devices 100a and 100b also detect skeletal information on a person seen in images (a customer in this example). In the second embodiment, the sensor devices 100a and 100b detect at least the customer's wrists as parts of his/her skeletal frame. The skeletal information includes positional information on the parts of the skeletal frame. The positional information includes the positions and depths of the parts of the skeletal frame in the images. The depth refers to the pixel-based distance from the sensor device to the subject.

The sensor devices 100a and 100b transmit the data of captured images and the detected skeletal information to the product information providing apparatus 200 at predetermined time intervals. The sensor devices 100a and 100b may also transmit the image data and information indicative of the pixel-based depths of the images to the product information providing apparatus 200.

The product information providing apparatus 200 is a computer that outputs product information on products determined as attracting the interest of the customer. The “product information” refers to information about the products. The product information includes a plurality of data items such as price, color, and the like. Upon each receipt of image data and skeletal information from the sensor devices 100a and 100b, the product information providing apparatus 200 analyzes the received image data and skeletal information to detect the products viewed by the customer in the images, and then stores the detected information in a predetermined storage area. Customers are likely to spend more time viewing products they like more. Thus, the product information providing apparatus 200 determines the products viewed by the customer as products attracting the interest of the customer.

The product information providing apparatus 200 receives a request for transmission of comparison information from the terminal device 300. The product information providing apparatus 200 identifies the customer on the basis of information included in the request for transmission of comparison information.

The product information providing apparatus 200 selects one of the plurality of products viewed by the identified customer. The product information providing apparatus 200 generates comparison information for comparison between the selected product and each of the other products out of the plurality of products viewed by the customer, and transmits the same to the terminal device 300.

The terminal device 300 displays the information on the products viewed by the customer. The terminal device 300 is held by each store clerk in the store. The terminal device 300 transmits a request for transmission of comparison information to the product information providing apparatus 200 according to the store clerk's operation. The terminal device 300 receives the comparison information from the product information providing apparatus 200 and displays the same on the display.

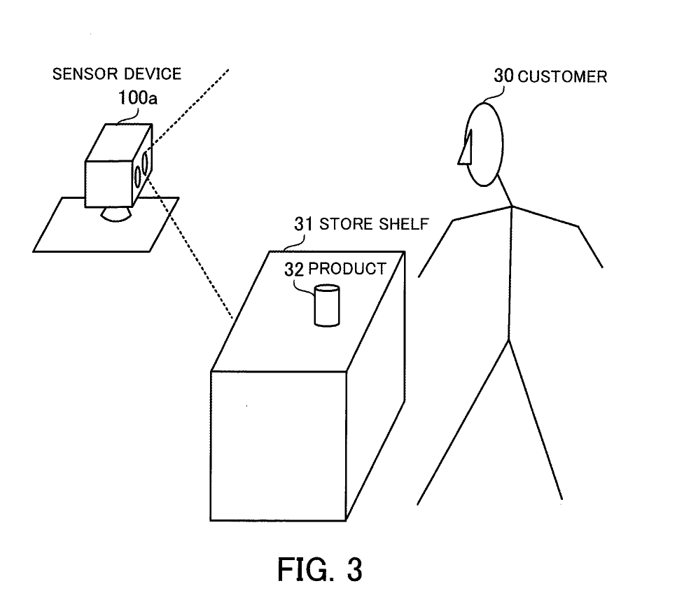

FIG. 3 illustrates an example of placement of a sensor device. In the example of FIG. 3, a product 32 is arranged on the upper surface of a store shelf 31. The right part of FIG. 3 is where a customer 30 walks around. The sensor device 100a is placed opposite to the movement area of the customer 30 relative to the store shelf 31. In this case, the sensor device 100a transmits to the product information providing apparatus 200 the data of the images of the customer 30, the store shelf 31, and the product 32, and the skeletal information on the customer 30. This placement of the sensor device 100a enables the product information providing apparatus 200 to determine whether the customer has viewed the product 32 on the store shelf 31, based on the information received from the sensor device 100a.

The sensor device 100b also captures images of an area where products are arranged on a store shelf different from the store shelf 31, in the same positional relation as that between the sensor device 100a and the store shelf 31 illustrated in FIG. 3. Therefore, the product information providing apparatus 200 is able to determine whether a customer have viewed a product arranged on the captured store shelf, based on information received from the sensor device 100b.

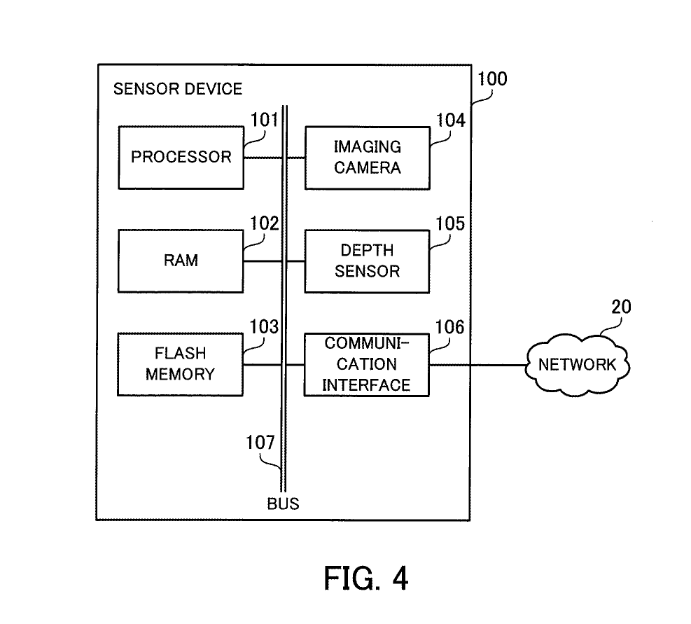

FIG. 4 illustrates an example of a hardware configuration of the sensor device. Since the sensor devices 100a and 100b have the same hardware configuration, these devices will be referred to collectively as “sensor device 100” in the following description referring to FIG. 4. In addition, hereinafter, the term “sensor device 100” will be used in the case where the sensor devices 100a and 100b do not need to be differentiated.

The sensor device 100 has a processor 101, a RAM (random access memory) 102, a flash memory 103, an imaging camera 104, a depth sensor 105, and a communication interface 106. These units are connected to a bus 107 within the sensor device 100.

The processor 101 includes a computing unit that executes program instructions and is, for example, a CPU (central processing unit). The processor 101 loads at least part of programs and data from the flash memory 103 to the RAM 102 and executes the programs. The processor 101 may include a plurality of processor cores. The sensor device 100 may include a plurality of processors. The sensor device 100 may use the plurality of processors or the plurality of processor cores to perform parallel processing. The “processor” may be an assembly of two or more processors, a dedicated circuit such as FPGA (field programmable gate array) and ASIC (application specific integrated circuit), an assembly of two or more dedicated circuits, or a combination of a processor and a dedicated circuit.

The RAM 102 is a volatile memory that temporarily stores programs to be executed by the processor 101 and data to be referred to in the programs. The sensor device 100 may include a memory of a kind other than RAM or may include a plurality of volatile memories.

The flash memory 103 is a non-volatile storage device that stores programs and data for firmware, application, and other kinds of software. The sensor device 100 may include another kind of a storage device, such as an HDD (hard disk drive), or may include a plurality of non-volatile storage devices.

The imaging camera 104 captures images and outputs the data of the captured images to the processor 101.

The depth sensor 105 measures the depths of pixels in the images captured by the imaging camera 104, and outputs the same to the processor 101. As a method for measuring the depths, for example, a TOF (time-of-flight) method may be used to measure the depths by a round-trip time of a laser light beam. Alternatively, there are various measurement methods including a pattern projection method for measuring a depth by distortion in a reflected light beam pattern (for example, infrared ray or the like). Any of these methods may be used. In the case of using the TOF method or the pattern projection method, the depth sensor 105 has a light emitting device for emitting a laser beam or infrared ray and a sensor for detecting the reflection component of the emitted light beam.

The communication interface 106 communicates with another information processing apparatus (for example, the product information providing apparatus 200) via a network, such as the network 20.

The programs to be executed by the processor 101 may be copied from another storage device to the flash memory 103.

The sensor device 100 may be a Kinect (registered trademark) sensor produced by Microsoft Corporation, for example. Alternatively, the sensor device 100 may be any of sensor devices with the function of identifying products attracting the interest of a customer depending on what products have been picked up by him/her or what products have been viewed by him/her.

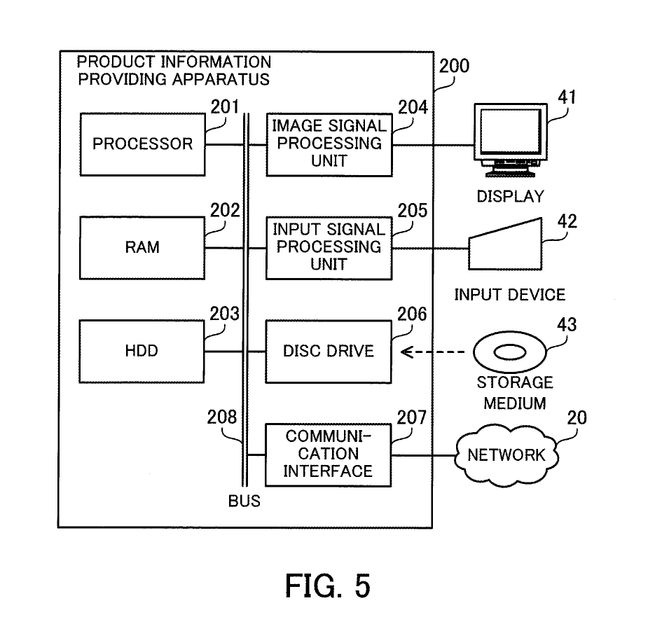

FIG. 5 illustrates an example of a hardware configuration of a product information providing apparatus. The product information providing apparatus 200 has a processor 201, a RAM 202, an HDD 203, an image signal processing unit 204, an input signal processing unit 205, a disc drive 206, and a communication interface 207. These units are connected to a bus 208 within the product information providing apparatus 200.

The processor 201 includes a computing unit that executes program instructions, as the processor 101 does. The RAM 202 is a volatile memory that temporarily stores programs and data to be executed by the processor 201, as the RAM 102 is.

The HDD 203 is a non-volatile storage device that stores software programs and data, such as an OS (operating system), firmware, application software, and the like. The product information providing apparatus 200 may include another kind of a storage device, such as a flash memory, or may include a plurality of non-volatile storage devices.

The image signal processing unit 204 outputs images to a display 41 connected to the product information providing apparatus 200 under instructions from the processor 201. The display 41 may be a CRT (cathode ray tube) display, a liquid crystal display, or the like.

The input signal processing unit 205 receives an input signal from an input device 42 connected to the product information providing apparatus 200 and gives the received input signal to the processor 201. The input device 42 may be a pointing device, such as a mouse and a touch panel, a keyboard, or the like.

The disc drive 206 is a drive device that reads programs and data from a storage medium 43. The storage medium 43 may be a magnetic disc, such as an FD (flexible disk) and an HDD, an optical disc, such as a CD (compact disc) and a DVD (digital versatile disc), or an MO (magneto-optical disc). The disc drive 206 stores the programs and data read from the storage medium 43 in the RAM 202 or the HDD 203, under instructions from the processor 201.

The communication interface 207 communicates with another information processing apparatus (for example, the sensor device 100a) via a network, such as the network 20.

The product information providing apparatus 200 does not need to include the disc drive 206. The product information providing apparatus 200, when it is to be exclusively controlled by another terminal device, does not need to include the image signal processing unit 204 or the input signal processing unit 205. The display 41 and the input device 42 may be integrated with the housing of the product information providing apparatus 200.

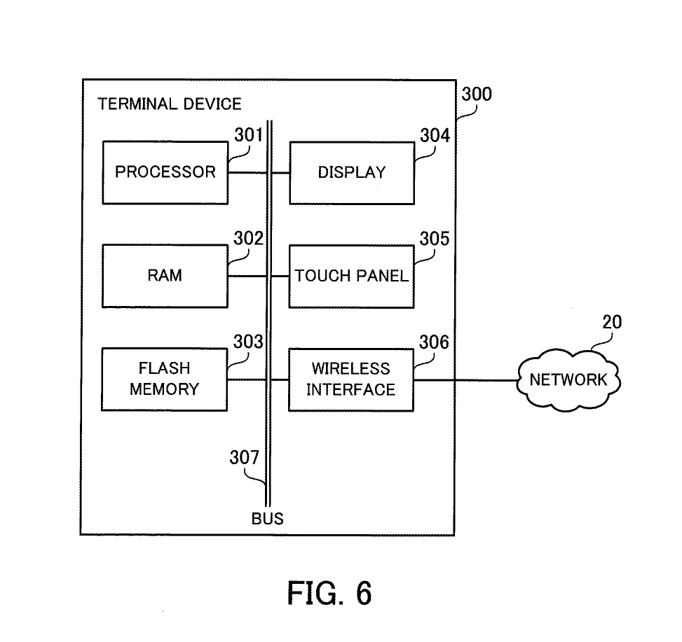

FIG. 6 illustrates an example of a hardware configuration of a terminal device. The terminal device 300 has a processor 301, a RAM 302, a flash memory 303, a display 304, a touch panel 305, and a wireless interface 306. These units are connected to a bus 307 within the terminal device 300.

The processor 301 includes a computing unit that executes program instructions, as the processor 101 does. The RAM 302 is a volatile memory that temporarily stores programs and data to be executed by the processor 301, as the RAM 102 is.

The flash memory 303 is a non-volatile storage device that stores programs and data such as an OS, firmware, and application software. The terminal device 300 may include another kind of a storage device such as an HDD or may include a plurality of non-volatile storage devices.

The display 304 displays images under instructions from the processor 301. The display 304 may be an LCD (liquid crystal display), organic EL (electro luminescence) display, or the like.

The touch panel 305 is placed on the display 304 to detect a touch operation by the user on the display 304 and notify the processor 301 of the touch position in the form of an input signal. The touch operation is performed with a pointing device, such as a touch pen or the like, and a user's finger. To detect the touch position, there are various methods including a matrix switch method, a resistive film method, a surface acoustic wave method, an infrared ray method, an electromagnetic induction method, and an electrostatic capacitance method, for example, and any of the methods may be utilized. The terminal device 300 may include another kind of an input device, such as a keypad with a plurality of input keys or the like.

The wireless interface 306 is a communication interface for wireless communications. The wireless interface 306 demodulates or decodes received signals or encodes or modulates transmission signals. For example, the wireless interface 306 connects to the network 20 or the like via an access point (not illustrated). The terminal device 300 may include a plurality of wireless interfaces.

The programs to be executed by the processor 301 may be copied from another storage device to the flash memory 303. The programs to be executed by the processor 301 may be downloaded by the wireless interface 306 from the network 20 or the like.

The following describes how the product information providing apparatus 200 determines a product viewed by a customer. When the customer picks up a product, the product information providing apparatus 200 determines that the customer has viewed the product and is interested in the product.

When detecting that a customer's hand has entered and then left a product arrangement area, the product information providing apparatus 200 compares an image of the product arrangement area captured at that time with a reference image captured in advance, thereby to determine whether the customer has picked up a product. The product arrangement area refers to a certain space in which a predetermined product is arranged. For example, the product arrangement area ranges from the upper surface of a store shelf on which the predetermined product is arranged to the position at a specific height above the upper surface of the store shelf.

A process for determining whether a customer's hand has entered an area in a three-dimensional space would be complicated. Therefore, the product information providing apparatus 200 sets a two-dimensional area corresponding to the product arrangement area in a captured image, and determines whether a customer's hand has entered the product arrangement area depending on whether the customer's hand (for example, a typical point of his/her wrist) is located within the set two-dimensional area. In the following description, the two-dimensional area corresponding to a product arrangement area set in a captured image may be hereinafter referred to as a “set area.”

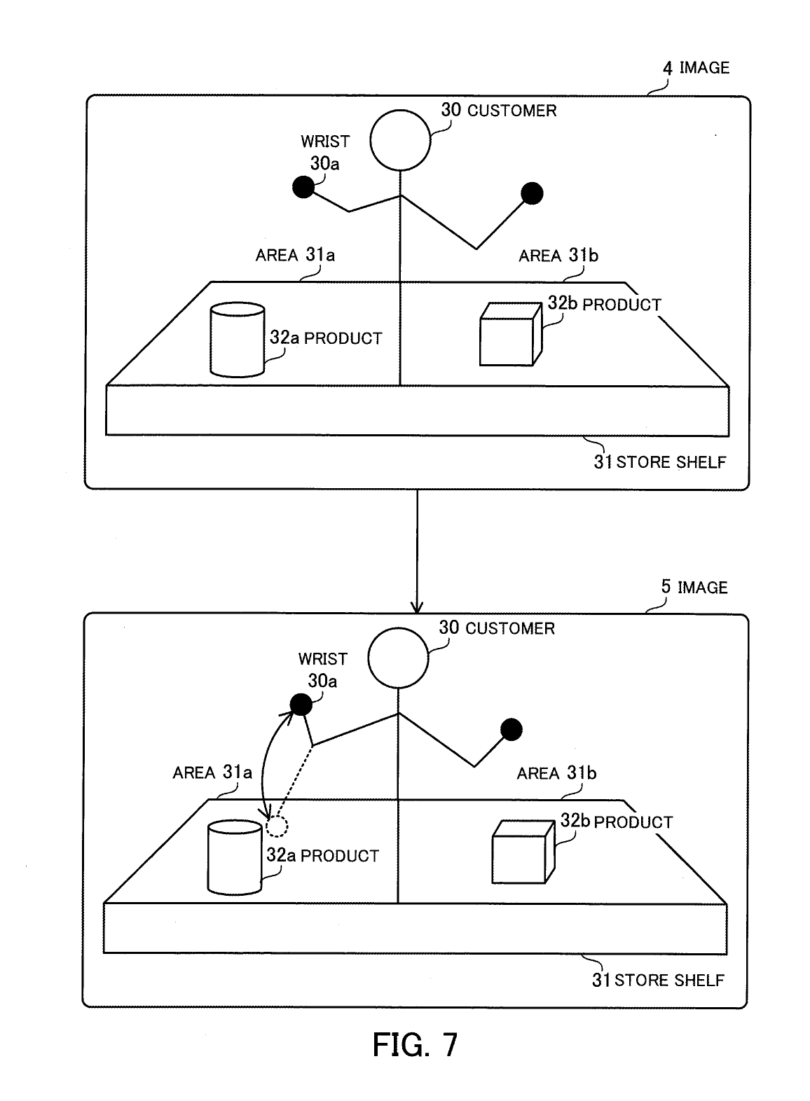

FIG. 7 illustrates an example of how to determine a product viewed by a customer. An image 4 is captured by the sensor device 100a. In the image 4, a customer 30, a store shelf 31, and products 32a and 32b are seen.

The store shelf 31 is placed in front of the sensor device 100a. Areas 31a and 32b are set areas corresponding to product arrangement areas where different products are arranged on the store shelf 31. The areas 31a and 31b are set arbitrarily in the image by the user. For example, the product 32a is arranged in the product arrangement area corresponding to the area 31a, and the product 32b is arranged in the product arrangement area corresponding to the area 31b. The customer 30 is located behind the store shelf 31 as seen from the sensor device 100a. A wrist 30a is the right wrist of the customer 30. In the image 4, the wrist 30a is not located in either of the area 31a or 31b corresponding to the product arrangement area.

Descriptions will be given below as to the case where it is determined whether the customer 30 has picked up the product 32a by the right hand.

Whether the right hand of the customer 30 has entered the product arrangement area in which the product 32a is arranged is determined depending on whether the right wrist 30a of the customer 30 is located within the area 31a. Assume now that, after the image 4 is captured, the product information providing apparatus 200 detects that the wrist 30a is located within the area 31a and then detects that the wrist 30a is located outside of the area 31a. That is, the product information providing apparatus 200 detects that the right hand of the customer 30 has entered and then left the product arrangement area of the product 32a.

An image 5 is an example of an image captured by the sensor device 100a at that time. Hereinafter, the same contents of the image 5 as those of the image 4 will not be described. In the image 5, as in the image 4, the product 32a is in the product arrangement area corresponding to the area 31a, and the product 32b is in the product arrangement area corresponding to the area 31b.

The product information providing apparatus 200 compares the area 31a in the image 4 with the area 31a in the image 5. In each of the images 4 and 5, the product 32a is positioned within the area 31a. Thus, the product information providing apparatus 200 determines that the hand of the customer 30 has entered the product arrangement area of the product 32a but the customer 30 has not picked up the product 32a.

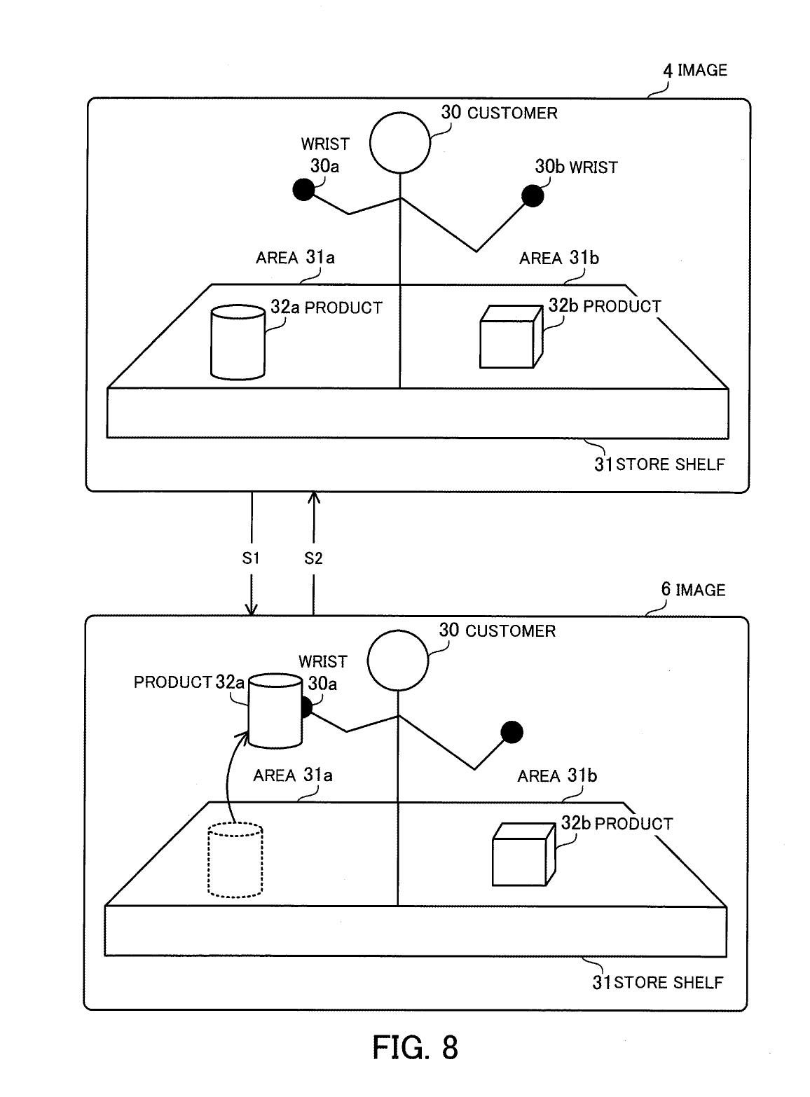

FIG. 8 illustrates an example of how to determine a product viewed by a customer (continued from FIG. 7). The image 4 illustrated in FIG. 8 indicates the same state as the image 4 of FIG. 7. It is assumed that, after this state, the product information providing apparatus 200 detects that the wrist 30a is located within the area 31a, and then detects that the wrist 30a is located outside of the area 31a.

An image 6 is an example of an image captured by the sensor device 100a at that time. Hereinafter, the same contents of the image 6 as those of the image 4 will not be described. In the image 6, the product 32a is not in the product arrangement area corresponding to the area 31a, and the product 32b is in the product arrangement area corresponding to the area 31b.

The product information providing apparatus 200 compares the area 31a in the image 4 with the area 31a in the image 6. The product 32a is positioned within the area 31a in the image 4, but the product 32a is not positioned within the area 31a in the image 6. Thus, the product information providing apparatus 200 determines that the customer 30 has picked up the product 32a (S1).

It is now assumed that, after that, the product information providing apparatus 200 detects again that the wrist 30a is located within the area 31a, and then detects that the wrist 30a is located outside of the area 31a. At that time, the same image of the area 31a as the image 4 is captured. For the sake of simplification, the following description will be given on the assumption that the image 4 is captured by the sensor device 100a at that time.

The product information providing apparatus 200 compares the area 31a in the image 6 with the area 31a in the image 4. The product 32a is not positioned within the area 31a in the image 6, but the product 32a is positioned within the area 31a in the image 4. Thus, the product information providing apparatus 200 determines that the customer 30 has placed back the product 32a (S2).

From the foregoing procedure, the product information providing apparatus 200 determines that the customer has picked up the product and then has placed it back. When the customer has picked up the product, the product information providing apparatus 200 determines that the customer has started to view the product, and when the customer has placed back the product, the product information providing apparatus 200 determines that the customer has ended viewing the product. The product information providing apparatus 200 measures the time from the start to the end of viewing as “viewing duration,” and calculates and stores the total cumulative amount of viewing duration for each product.

In general, a customer picks up a product of his/her interest and considers whether to buy it. The customer is likely to hold a product of higher interest for a longer time. Therefore, by calculating the duration during which the customer holds a product as viewing duration described above, it is possible to accurately determine the degree of interest the customer has in the product.

Although not described with reference to FIGS. 7 and 8, the product information providing apparatus 200 also determines whether the customer 30 has viewed a product according to results of determining the positional relation between the left wrist 30b and a set area and results of comparison between the images with respect to the set area, as in the case of the right wrist 30a. This makes it possible to determine whether the customer 30 has picked up the product 32b by the left hand while determining that the customer 30 has picked up the product 32a by the right hand, for example.

Alternatively, the product information providing apparatus 200 may determine whether a customer has picked up a product arranged in the product arrangement area corresponding to a set area, depending on whether there are any differences between images of the set area captured before and after a wrist of the customer has entered and left the set area. Still alternatively, the product information providing apparatus 200 may determine whether a customer has picked up a product based on whether a non-contact IC reader held by the customer has read information from an IC tag attached to the product. Further alternatively, the product information providing apparatus 200 may determine whether a customer has picked up a product based on whether a barcode reader held by the customer has read a barcode attached to the product.

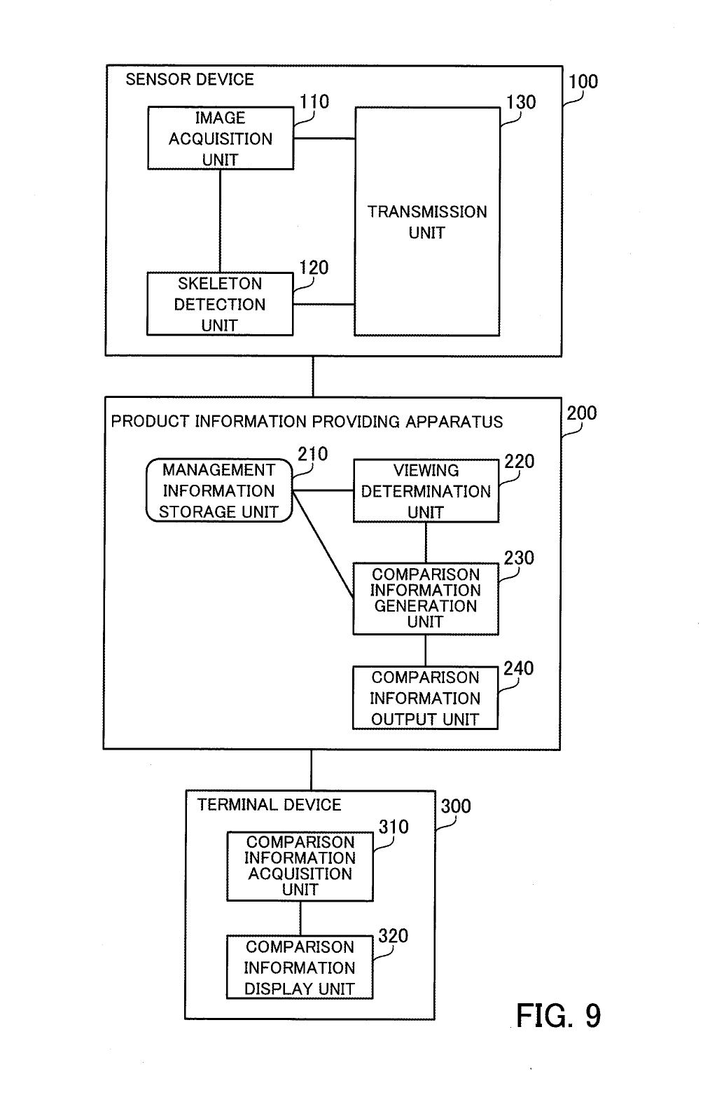

Referring to FIG. 9 and the subsequent drawings, descriptions will be given as to a method by the product information providing system 3 to display on the terminal device 300 comparison information on products attracting the interest of the customer 30.

FIG. 9 illustrates an example of functions of the sensor device, the product information providing apparatus, and the terminal device. A sensor device 100 has an image acquisition unit 110, a skeleton detection unit 120, and a transmission unit 130.

The image acquisition unit 110 acquires the data of images captured by the imaging camera 104 at predetermined time intervals.

The skeleton detection unit 120 detects the positions of pre-decided parts of the skeletal frame of a person seen in the images, such as his/her wrists or the like, based on the image data and depth information from the depth sensor 105. Each time the image acquisition unit 110 acquires image data, the skeleton detection unit 120 detects the positions of the skeletal parts in the image and generates skeletal information including positional information on the skeletal parts. The positional information on the skeletal parts includes information indicative of the coordinates of the parts in the image and information indicative of the depths of the parts. When a plurality of people is seen in the image, the skeleton detection unit 120 may generate skeletal information on each of the people.

The transmission unit 130 transmits the data of the captured images and the skeletal information on the customer seen in the image to the product information providing apparatus 200. The data of the captured images includes a device ID identifying a sensor device.

The processes at the image acquisition unit 110, the skeleton detection unit 120, and the transmission unit 130 are realized by the processor 101 executing predetermined programs. The sensor devices 100a and 100b illustrated in FIG. 2 have the same functions as those of the sensor device 100.

The product information providing apparatus 200 has a management information storage unit 210, a viewing determination unit 220, a comparison information generation unit 230, and a comparison information output unit 240.

The management information storage unit 210 stores a store shelf information table holding information on store shelves placed in a store and an area information table holding information on set areas corresponding to product arrangement areas. The management information storage unit 210 also stores a product information table holding information on products handled by the store, and a customer information table holding information on customers. The management information storage unit 210 further stores a viewed product information table holding information on products viewed by a customer. The management information storage unit 210 is realized as a non-volatile storage area provided in the HDD 203, for example. However, the customer information table and the viewed product information table may be stored in a storage area temporarily provided in the RAM 202, for example.

The viewing determination unit 220 receives the image data and the skeletal information on the customer seen in the image from the sensor device 100. The viewing determination unit 220 determines whether the customer has viewed a product based on the received information and the information held in the store shelf information table and the area information table. The viewing determination unit 220 also generates information on the products viewed by the customer and holds the same in the viewed product information table. The information on the products viewed by the customer includes information indicating when and how many times the products were viewed, for example.

The comparison information generation unit 230 receives a request for transmission of comparison information from the terminal device 300. The comparison information is part of the information on the products viewed by the customer. In the request for transmission of comparison information, a store shelf in the store is specified. The comparison information generation unit 230 identifies the product most viewed by the customer according to the specified store shelf, the store shelf information table, and the viewed product information table. Hereinafter, the product most viewed by a customer may be referred to as “most-viewed product.”

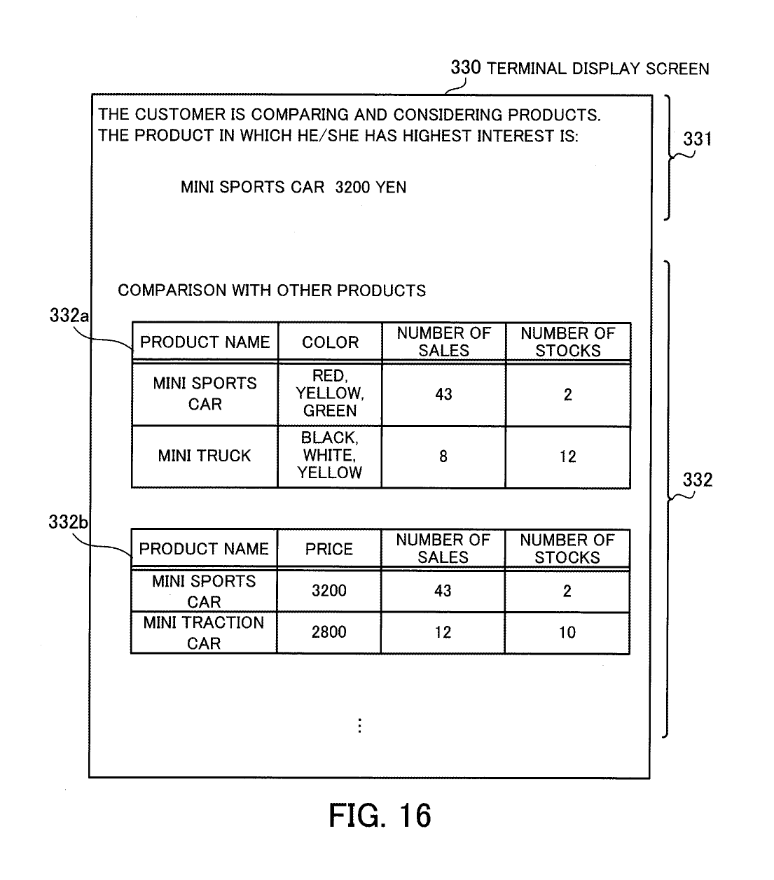

Based on the information on the products viewed by the customer, the comparison information generation unit 230 generates comparison information for comparison between the most-viewed product and each of the other products. A method for generation of comparison information will be described later in detail with reference to FIG. 16.

The comparison information output unit 240 transmits the generated comparison information to the terminal device 300. The comparison information output unit 240 also transmits on a regular basis the contents of the customer information table to the terminal device 300.

The processes at the viewing determination unit 220, the comparison information generation unit 230, and the comparison information output unit 240 are realized by the processor 201 executing predetermined programs, for example.

The terminal device 300 has a comparison information acquisition unit 310 and a comparison information display unit 320.

The comparison information acquisition unit 310 specifies a store shelf in the store according to the store clerk's input operation and requests the product information providing apparatus 200 to transmit comparison information. The comparison information acquisition unit 310 receives the comparison information from the product information providing apparatus 200. The comparison information display unit 320 causes the display 304 to display a terminal display screen containing the received comparison information.

The processes at the comparison information acquisition unit 310 and the comparison information display unit 320 are realized by the processor 301 executing predetermined programs, for example.

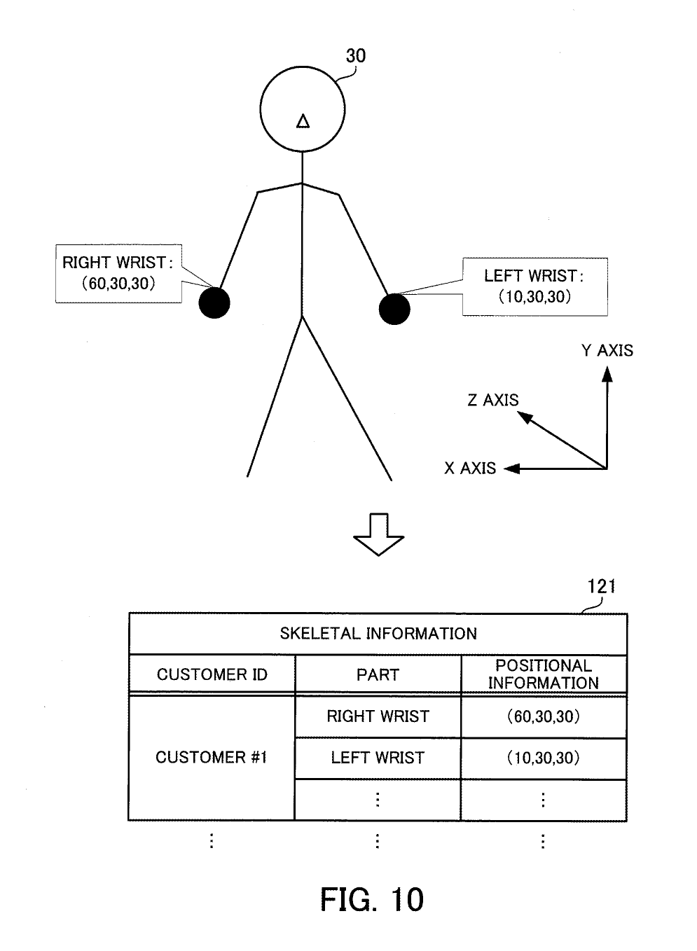

Next, information, tables, and screens used in the product information providing system 3 will be described with reference to FIGS. 10 to 16.

FIG. 10 illustrates an example of skeletal information. Skeletal information 121 indicates the positions of parts in the customer's skeletal frame, such as the head and the joints in the wrists. The skeletal information 121 is generated by the skeleton detection unit 120. The skeletal information 121 has the following data items: customer ID, part, and positional information.

Set in the data item of customer ID are identifiers for identifying the customers seen in an image. Set in the data item of part is information indicative of the kinds of parts in the skeletal frame.

Set in the data item of positional information is positional information on the parts. In the product information providing system 3, the positional information is represented as “(position on X axis, position on Y axis, and position on Z axis).” The X axis is a horizontal axis orthogonal to the optical axis of the imaging camera 104, and the left side of the X axis as seen from the imaging camera 104 is regarded as positive. The Y axis is a vertical axis orthogonal to the optical axis of the imaging camera 104, and the upper side of the Y axis as seen from the imaging camera 104 is regarded as positive. The Z axis is parallel to the optical axis of the imaging camera 104, and the side of the Z axis toward which the imaging camera 104 faces is regarded as positive. That is, the positions of the parts of a skeletal frame in an image are represented by the coordinates of the X and Y axes, and the depths of the parts in the skeletal frame are represented by the coordinate of the Z axis.

As illustrated in FIG. 10, for example, the right wrist, the left wrist, and others are detected as parts of the skeletal frame. Assuming that the coordinates of the right wrist of the customer 30 in the image are “(60, 30)” and the coordinate of the depth is “30,” the data item of positional information corresponding to the “right wrist” of the customer 30 in the skeletal information 121 is set to “(60, 30, 30).”

The positional information on the parts of the skeletal frame may be represented in a form other than the foregoing one, such as latitude, longitude, height, and the like.

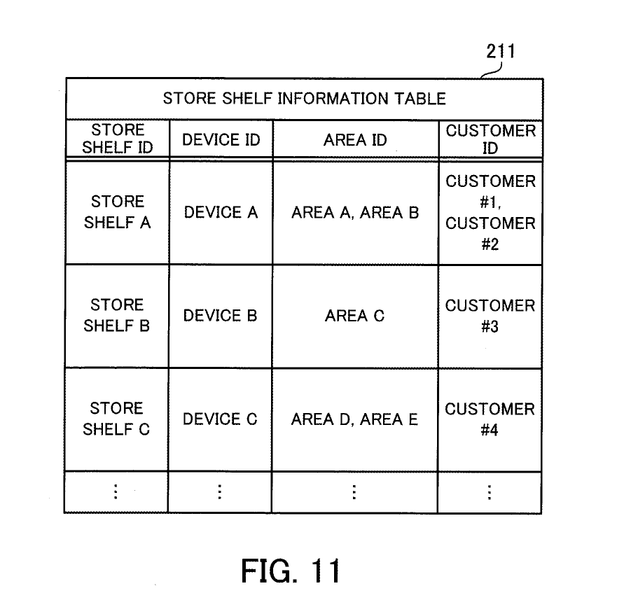

FIG. 11 illustrates an example of a store shelf information table. The store shelf information table 211 stores in advance information on store shelves in a store. The store shelf information table 211 is stored in the management information storage unit 210. The store shelf information table 211 has the following data items: store shelf ID, device ID, area ID, and customer ID.

Set in the data item of store shelf ID are identifiers for identifying the store shelves in the store. Set in the data item of device ID are identifiers for identifying sensor devices that capture images of the store shelves in the store. Set in the data item of area ID are identifiers for identifying the set areas corresponding to product arrangement areas of the store shelves. Set in the data item of customer ID are identifiers for identifying customers located near the store shelves. The identifiers set in the data item of customer ID indicate customers who have been captured by the corresponding sensor devices and skeletal information on whom has been obtained.

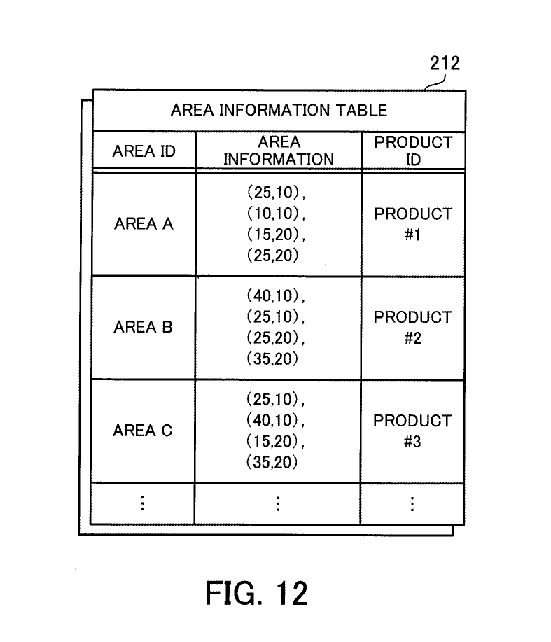

FIG. 12 illustrates an example of an area information table. The area information table 212 is prepared for each of the sensor devices (that is, for each of the store shelves) and stored in the management information storage unit 210. Each of the area information tables 212 stores in advance information on set areas that are set to images captured by the corresponding sensor device. The area information table 212 has the following data items: area ID, area information, and product ID.

Set in the data item of area ID are identifiers for identifying the set areas.

Set in the data item of area information is information indicative of the ranges of the set areas. In the product information providing system 3, the set area is square in shape. The information indicative of the range of a set area is represented by the coordinates of the four corners of the area in which products are arranged. The coordinates of each of the four corners is represented by “(position on the X axis, position on the Y axis).” The shape of set areas is not limited to square but may be circular or oval. If set areas are rectangular in shape, the information indicative of each set area may be represented only by the upper right and lower left coordinates, for example.

Set in the data item of product ID are identifiers for identifying products arranged in the product arrangement areas corresponding to the set areas. In the product information providing system 3, one kind of product is arranged in one product arrangement area. Alternatively, a plurality of kinds of products may be arranged in one product arrangement area. In that case, a plurality of product IDs is set in the data item of product ID.

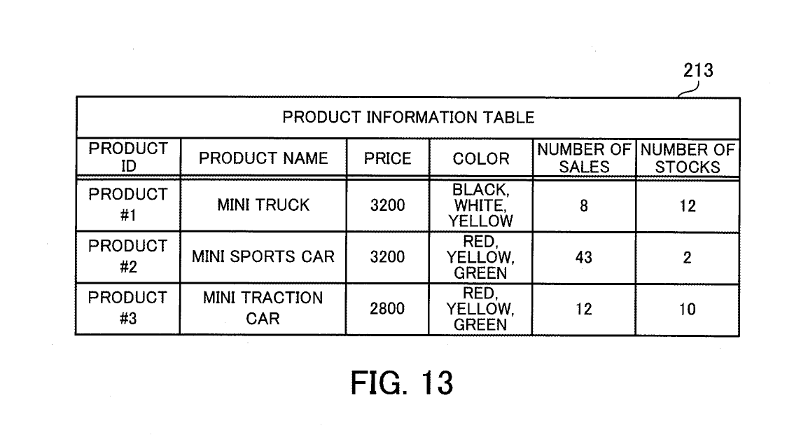

FIG. 13 illustrates an example of a product information table. The product information table 213 holds in advance information on products handled by the store. The product information table 213 is stored in the management information storage unit 210. The product information table 213 has the following data items: product ID, product name, price, color, number of sales, and number of stocks.

Set in the data item of product ID are identifiers for identifying products handled by the store. Set in the data item of product name are character strings indicative of product names as information to be displayed on the terminal device 300. Set in the data item of price is information indicative of the prices of the products.

Set in the data item of color is information indicative of colors as a feature of the products. For example, if a product is featured in colors of black, white, and yellow, the value “black, white, and yellow” is set in the data item of color. Color information set in the data item of color may indicate any number of colors.

Set in the data item of number of sales is information indicative of the number of products sold within a predetermined period of time (for example, within the latest one week). Set in the data item of number of stocks is information indicative of the number of products stocked in the store.

Hereinafter, of the information on the products stored in the product information table 213, data values registered in the data items except product ID may be referred to as “product information.”

The product information table 213 may contain the images of the products as well as the foregoing data items.

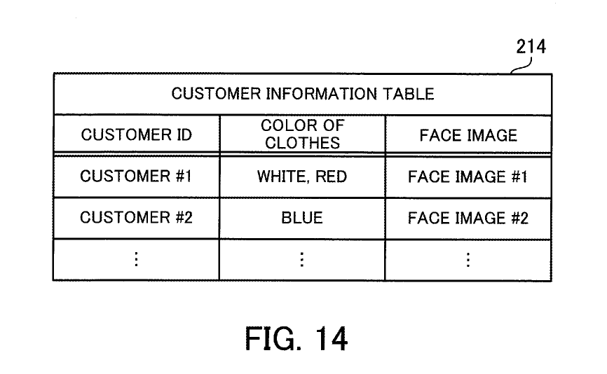

FIG. 14 illustrates an example of a customer information table. The customer information table 214 holds information on customers on whom skeletal information is detected by sensor devices. The customer information table 214 is stored in the management information storage unit 210. The customer information table 214 has the following data items: customer ID, color of clothes, and face image.

Set in the data item of customer ID are identifiers for identifying customers. Set in the data item of color of clothes is information indicative of one or more colors of the customers' clothes. Set in the data item of face image is information indicative of images of the customers' faces. The information indicative of images of the customers' faces may be the data of the images of the customers' faces or information indicative of links to the image data.

The customer information table 214 may contain information indicative of the customers' appearances, such as height, width, or the like, as well as the foregoing data items.

A supplementary explanation will be provided on the customer IDs. The customer IDs registered in the store shelf information table 211 and the customer information table 214 uniquely identify the customers located in the store. Meanwhile, the customer IDs included in the skeletal information 121 transmitted from the sensor devices are identifiers arbitrarily added by the sensor devices. Accordingly, even if one and the same customer is detected by a plurality of sensor devices, the sensor devices do not necessarily assign one and the same customer ID to the customer.

When receiving the skeletal information 121 from a sensor device and registering information on the customer corresponding to the skeletal information 121 in the customer information table 214, the viewing determination unit 220 acquires the features of the customer corresponding to the received skeletal information 121, from the image received from the sensor device. As the features of the customer, the colors of his/her clothes and his/her face image are acquired, for example.

If a customer with almost the same features as the acquired ones is not registered in the customer information table 214, the viewing determination unit 220 determines that the customer was newly detected and assigns the customer a new customer ID not related to the customer ID registered with the received skeletal information 121. In this case, the viewing determination unit 220 registers a new record corresponding to the customer in the customer information table 214, and registers the customer ID in the record of the appropriate store shelf in the store shelf information table 211.

Meanwhile, if a customer with almost the same features as the acquired ones is registered in the customer information table 214, the viewing determination unit 220 determines that the currently detected customer is identical to the already detected customer. For example, the viewing determination unit 220 compares the acquired features to the features registered in the records in the customer information table 214. If the customer information table 214 stores a record which has colors at least partly common and a face image similar more than certain degree to the acquired features, the viewing determination unit 220 determines that the currently detected customer is identical to the already detected customer. In this case, the viewing determination unit 220 does not register a new record in the customer information table 214 but registers the customer ID corresponding to the already registered customer in the record of the appropriate store shelf in the store shelf information table 211. As described above, the viewing determination unit 220 is able to determine that one and the same customer is detected by a plurality of sensor devices and assign one and the same customer ID to the customer.

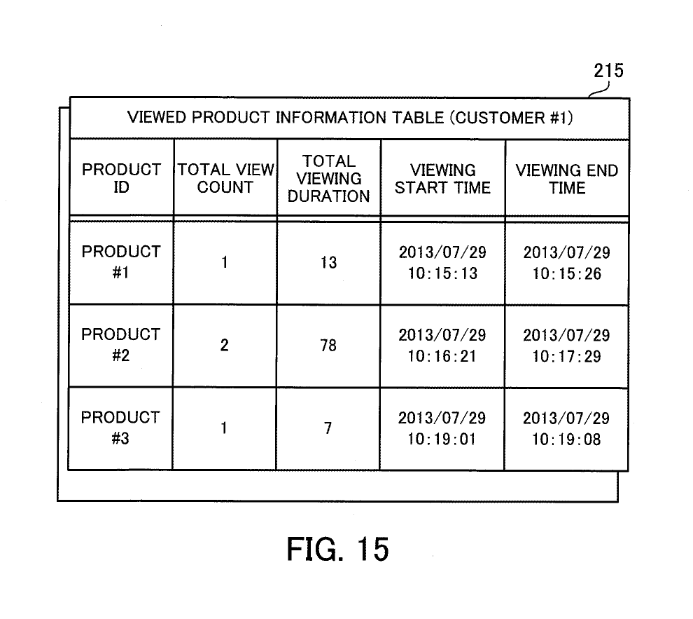

FIG. 15 illustrates an example of a viewed product information table. The viewed product information table 215 temporarily holds information on products viewed by a customer. The viewed product information table 215 is generated by the viewing determination unit 220 for each of the customers in the store and stored in the management information storage unit 210. For example, the viewed product information table 215 in FIG. 15 temporarily holds information on products viewed by a customer with the customer ID “customer #1.” The viewed product information table 215 has the following data items: product ID, total view count, total viewing duration, viewing start time, and viewing end time.

Set in the data item of product ID are identifiers for identifying products viewed by the customer.

Set in the data item of total view count is information indicative of the number of times the product has been viewed by the customer. Set in the data item of total viewing duration is information indicative of total time during which the product has been viewed by the customer. Set in the data item of viewing start time is information indicating when the customer started to view the product the last time. Set in the data item of viewing end time is information indicating when the customer ended viewing the product the last time.

FIG. 16 illustrates an example of contents of comparison information and display of the same. In the following description, the products identified by the product IDs registered in each of the foregoing tables may be merely represented by their product IDs. For example, the product identified by an ID “product #2” will be merely represented as “product #2.”

A terminal display screen 330 displays, for each of the customers in the store, comparison information on products viewed by the customers. The terminal display screen 330 appears on the display 304 of the terminal device 300. Descriptions will be given below with reference to FIG. 16 on the assumption that the information as illustrated in FIGS. 13 and 15 is registered in the product information table 213 and the viewed product information table 215, respectively.

The terminal display screen 330 contains a most-viewed product display field 331 and a product comparison display field 332. The most-viewed product display field 331 and the product comparison display field 332 provide information on one customer located near one store shelf. The store shelf is specified by the terminal device 300 when a request is made to the product information providing apparatus 200 for transmission of comparison information, according to store clerk's input operation, for example.

The most-viewed product display field 331 provides, of the product information registered in the viewed product information table 215 corresponding to the customer, information including the product name and price of the most-viewed product. The product comparison display field 332 provides information including comparison information 332a and 332b. The comparison information 332a and 332b is formed by extracting, from product information on the most-viewed product and other viewed products registered in the viewed product information table 215 corresponding to the customer, data items each having different data values and the data values of the data items, for each of the other viewed products.

For example, of the total viewing durations corresponding to the products registered in the viewed product information table 215 in FIG. 15, the longest total viewing duration is “78.” Accordingly, the product information providing apparatus 200 identifies the “product #2” corresponding to “78” as a most-viewed product. After that, the product information providing apparatus 200 transmits to the terminal device 300 information indicative of “mini sports car” and “3200” as information indicative of the product name and price of the most-viewed product.

Then, the terminal device 300 receives the information indicative of the product name and price of the most-viewed product, and displays the contents of the information including “mini sports car” and “3200” as the product name and price of the most-viewed product in the most-viewed product display field 331.

The contents of the information on the most-viewed product displayed in the most-viewed product display field 331 may include the image and the number of sales of the most-viewed product as well as the product name and the price.

The comparison information generation unit 230 generates the comparison information 332a and 332b in a manner as described below. First, the comparison information generation unit 230 refers to the viewed product information table 215 corresponding to the customer to generate combinations of the most-viewed product and the other products. Then, the comparison information generation unit 230 refers to the product information table 213 to compare the product information on the most-viewed product with the product information on the other products, and extract combinations of products with at least one data item having different data values registered. Then, the comparison information generation unit 230 generates, for each extracted combinations of products, comparison information containing the names of the data items each having different data values registered and the data values of the data items with respect to the products.

For example, referring to FIG. 16, the comparison information 332a is generated for comparison between the “product #2” as the most-viewed product and the “product #1” as one of the other products. As illustrated in FIG. 13, the product information on the “product #2” as the most-viewed product and the product information on the “product #1” are different in the data items of product name, color, number of sales, and number of stocks. Accordingly, the comparison information 332a indicates the data items of product name, color, number of sales, and number of stocks, and the registered data values of the data items corresponding to the “product #2” and “product #1.” Similarly, as information for comparison between the “product #2” and “product #3,” the comparison information 332b is generated containing the data items of product name, price, number of sales, and number of stocks, and the registered data values thereof.

The product information providing apparatus 200 transmits the generated comparison information 332a and 332b to the terminal device 300. After that, the comparison information 332a and 332b is displayed in the product comparison display field 332 on the terminal display screen 330 as illustrated in FIG. 16.

If a plurality of pieces of comparison information is generated, the pieces of information are sorted and output in descending order of the total view counts of the products other than the most-viewed product included in the comparison information, and are displayed on the terminal display screen 330. Sorting the information allows the store clerk to easily recognize the information on the products attracting high interest of the customer. Instead of the total view counts, the comparison information may be sorted and displayed in the order of the total viewing duration, or may be sorted according to any of the data items having different registered data values, or may be displayed in arbitrary order.

When a customer is considering which of interesting products to buy, he/she may refer to, of various kinds of information about the products, information of kinds with contents different between the products. As described above with reference to FIG. 16, the product information providing apparatus 200 extracts data items each having different data values between the products registered in the viewed product information table 215. This makes it possible to identify, of all the information on the products attracting the interest of the customer, information useful for him/her to select a product to purchase.

Of all the products determined as attracting the interest of the customer, a product determined as attracting his/her highest interest is most likely to be bought by him/her. Thus, as illustrated in FIG. 16, by generating the comparison information for comparison between product information on the product attracting the highest interest of the customer and product information on the other products, it is possible to identify information more useful for the customer to select a product (information the customer wants much more).

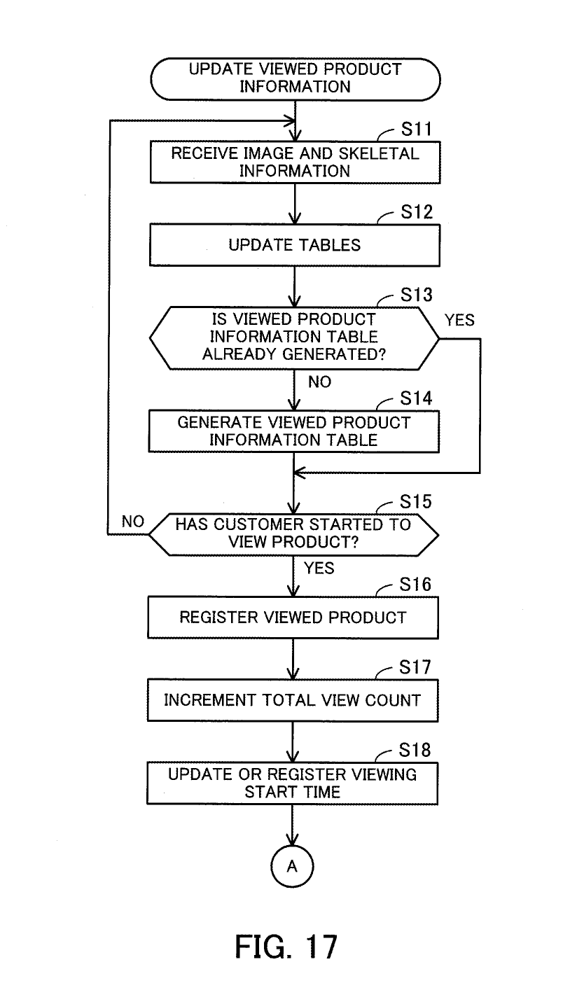

Next, referring to FIGS. 17 to 19, processes executed by the product information providing apparatus 200 will be described.

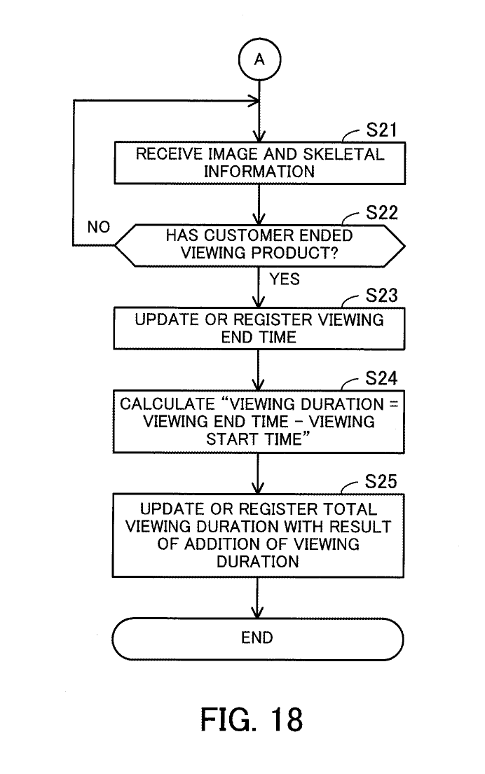

FIGS. 17 and 18 are a flowchart of an example of a process for updating viewed product information. The product information providing apparatus 200 executes the process described in FIGS. 17 and 18 upon receipt of an image and skeletal information from any of the sensor devices 100. In the description of FIGS. 17 and 18, it is assumed that one customer is seen in the image received from the sensor device 100, and at start of the process described in FIGS. 17 and 18, the customer's wrists are not located in any of set areas for products in the image. The process described in FIGS. 17 and 18 will be described with the step numbers.

(S11) The viewing determination unit 220 receives the data of a captured image and skeletal information on the customer seen in the image from the sensor device 100. The image data contains the device ID of the sensor device having captured the image. Hereinafter, the process of FIGS. 17 and 18 will be performed using the image received from the same sensor device 100.

(S12) The viewing determination unit 220 updates tables in a manner as described below.

First, the viewing determination unit 220 analyzes the area where the detected customer is located in the image received at step S11 to extract the colors of his/her clothes and his/her face image. The viewing determination unit 220 compares the extracted colors of the clothes and face image with the information registered in the customer information table 214, and determines whether the detected customer is an already registered customer according to the procedure described earlier.

If the detected customer is a newly detected customer, the viewing determination unit 220 assigns a new customer ID to the customer, adds a record to the customer information table 214, and registers the new customer ID, extracted colors of clothes and face image in that record. Meanwhile, if the detected customer is an already detected customer, the viewing determination unit 220 skips the process for registration in the customer information table 214.

The viewing determination unit 220 also searches the store shelf information table 211 for the record including the device ID contained in the received image data. Next, the viewing determination unit 220 registers the customer ID of the detected customer in the data item of customer ID in the retrieved record.

(S13) The viewing determination unit 220 determines whether the viewed product information table 215 has been already generated for the detected customer. If the viewed product information table 215 is not yet generated for the customer, the viewing determination unit 220 moves the process to step S14. If the viewed product information table 215 is already generated for the customer, the viewing determination unit 220 moves the process to step S15.

(S14) The viewing determination unit 220 newly generates the viewed product information table 215 for the customer.

(S15) The viewing determination unit 220 determines whether the customer has started to view a product based on the received image, by the method described earlier with reference to FIGS. 7 and 8. That is, the viewing determination unit 220 determines whether the customer has picked up the product. At that time, data on the positions of the customer's wrists is acquired by reading positional information from the records of “right wrist” and “left wrist” contained in the skeletal information received at step S11.

The set areas corresponding to product arrangement areas are detected by reading the area IDs from the record corresponding to the sensor device 100 having transmitted the image out of all the records in the store shelf information table 211, and then reading area information from the record corresponding to the read area IDs out of all the records in the area information table 212. If determining that the customer has picked up a product corresponding to any of the read area information, the viewing determination unit 220 determines that the customer has started to view the product.

If the customer has started to view the product, the viewing determination unit 220 moves the process to step S16. If the customer has not started to view any product, the viewing determination unit 220 moves the process to step S11.

That is, the viewing determination unit 220 repeats steps S11 to S15 until receipt of an image describing that the customer has started to view a product.

(S16) The viewing determination unit 220 identifies the product ID of the product determined as having been started to be viewed by the customer. The product ID is identified from, of all the records in the area information table 212, the record containing information on the area where the product determined as having been picked up by the customer at step S15 is arranged.

If there is no record containing the identified product ID in the viewed product information table 215 corresponding to the detected customer, the viewing determination unit 220 registers a new record containing the product ID in the viewed product information table 215. At that time, “0” is entered in the data items of total view count and total viewing duration corresponding to the product.

(S17) The viewing determination unit 220 increments the value of the data item of total view count in the record containing the product ID identified at step S16 in the viewed product information table 215 corresponding to the detected customer.

(S18) The viewing determination unit 220 registers the current time in the data item of viewing start time in the record processed at step S17. If some value is already registered in that record, the value is updated to the current time.

Refer now to FIG. 18.

(S21) The viewing determination unit 220 receives an image and skeletal information from the sensor device 100.

(S22) The viewing determination unit 220 determines whether the customer has ended viewing the product by the method described earlier with reference to FIGS. 7 and 8. That is, the viewing determination unit 220 determines whether the customer has placed back the product.

If the customer has ended viewing the product, the viewing determination unit 220 moves the process to step S23. If the customer has not ended viewing the product, the viewing determination unit 220 moves the process to step S21.

That is, the viewing determination unit 220 repeats steps S21 and 22 until receipt of an image describing that the customer has ended viewing the product.

(S23) The viewing determination unit 220 searches the viewed product information table 215 for a record containing the product ID of the product determined as having been no longer viewed, and registers the current time in the data item of viewing end time in the retrieved record. If any value is already registered in that record, the value is updated to the current time.

(S24) The viewing determination unit 220 subtracts the viewing start time from the viewing end time in the record retrieved at step S23 to determine “viewing duration.”

(S25) The viewing determination unit 220 adds the viewing duration determined at step S24 to the value currently registered in the data item of total viewing duration in the record retrieved at step S23, thereby to update the data item of total viewing duration with the result of the addition.

The total view count may be incremented not at step S17 in FIG. 17 but after the customer has ended viewing the product (for example, after execution of step S23).

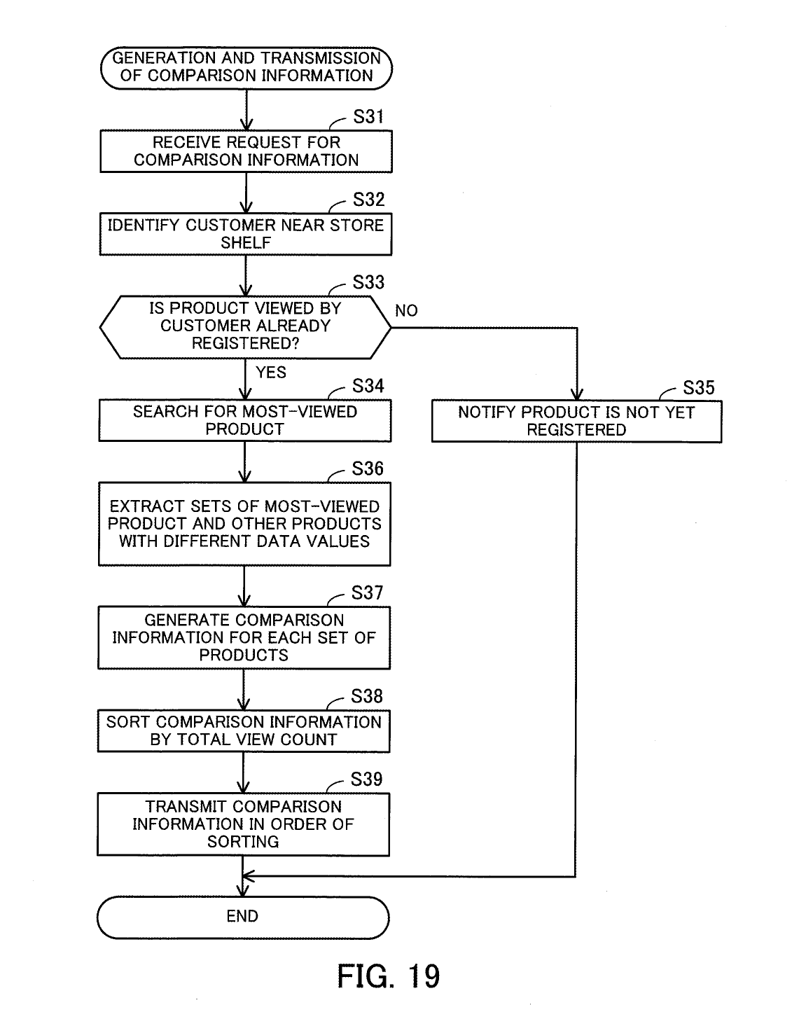

FIG. 19 is a flowchart of an example of a process for generating and transmitting comparison information.

To serve a customer located in front of a store shelf, for example, a store clerk holding the terminal device 300 performs an input operation on the terminal device 300 to specify the store shelf. According to the input operation, the terminal device 300 requests the product information providing apparatus 200 to transmit comparison information, and notifies the product information providing apparatus 200 of the identifier of the store shelf.

The process described in FIG. 19 is executed upon receipt of a request for transmission of comparison information from the terminal device 300. In the following description of FIG. 19, assume that one customer is located near a store shelf specified by the terminal device 300. The process described in FIG. 19 will be described below with the step numbers.

(S31) The comparison information generation unit 230 receives a request for transmission of comparison information from the terminal device 300. The request for transmission of comparison information contains the identifier of the store shelf (store shelf ID) specified by the terminal device 300.

(S32) The comparison information generation unit 230 identifies a customer located near the specified store shelf. Specifically, the comparison information generation unit 230 searches the store shelf information table 211 for a record containing the specified store shelf, and determines the customer identified by the customer ID of the retrieved record as the customer located near the specified store shelf. In this example, one customer is identified.

(S33) The comparison information generation unit 230 determines whether information on the product viewed by the customer identified at step S32 is already registered in the viewed product information table 215 corresponding to the identified customer. If the information is already registered in the viewed product information table 215, the comparison information generation unit 230 moves the process to step S34. If the information is not yet registered in the viewed product information table 215, the comparison information generation unit 230 moves the process to step S35.

(S34) The comparison information generation unit 230 searches the viewed product information 215 corresponding to the identified customer for a most-viewed product. Specifically, the comparison information generation unit 230 searches the viewed product information table 215 for a record with the longest total viewing duration, and determines the product in the retrieved record as the most-viewed product. The most-viewed product may be a product with the largest total view count instead of a product with the longest total viewing duration.

(S35) The comparison information generation unit 230 notifies the terminal device 300 that the information on the product viewed by the customer is not yet registered in the viewed product information table 215. In this case, the comparison information unit 320 of the terminal device 300 causes the display 304 to indicate that the information on the product in question is not yet registered.

(S36) The comparison information generation unit 230 generates combinations of the most-viewed product and the other products from the viewed product information table 215 corresponding to the identified customer. The comparison information generation unit 230 refers to the product information table 213 to compare the product information on the most-viewed product with the product information on the other product in each generated combinations of products. Then, the comparison information generation unit 230 extracts combinations of products with at least one data item having different data values between the most-viewed product and the other products.

(S37) The comparison information generation unit 230 generates comparison information for each of the combinations of products extracted at step S36. At this time, the comparison information generation unit 230 contains, in the generated comparison information for each combination, the data items having different data values between the corresponding products and the data values registered in the data items of the product information table 213.

(S38) If a plurality of pieces of comparison information is generated, the pieces of information are sorted according to the procedure described below. The comparison information generation unit 230 reads, from the viewed product information table 215, the total view counts of the products other than the most-viewed product, included in the comparison information. The comparison information generation unit 230 sorts the comparison information in descending order of the total view counts of the other products included in the comparison information. Instead of the total view counts, the comparison information may be sorted in the order of the total viewing duration.

(S39) The comparison information output unit 240 transmits the generated comparison information in the order of sorting to the terminal device 300. The comparison information output unit 240 also transmits information indicative of the price and product name of the most-viewed product to the terminal device 300. Specifically, the comparison information output unit 240 transmits the information indicative of the price and product name of the most-viewed product in the record retrieved at step S34.

After that, the terminal device 300 displays the contents of the received information indicative of the price and product name of the most-viewed product in the most-viewed product display field 331 on the terminal display screen 330, and displays the received comparison information in the product comparison display field 332 on the terminal display screen 330.

If a plurality of customers is identified at step S32, steps S33 to S39 are repeatedly executed for each of the identified customers. Then, the product comparison display field 332 is displayed for each of the customers on the terminal display screen 330. In this case, the store clerk identifies the customers to provide comparison information in a manner as described below, for example.

First, the terminal device 300 specifies a store shelf, receives information on a customer located near the specified store shelf (for example, the color of clothes and face image) from the product information providing apparatus 200, and displays the received information on the terminal display screen 330. The product information providing apparatus 200 retrieves the information on the customer on the basis of the specified store shelf, the information held in the store shelf information table 211 and the customer information table 214. Then, the store clerk visually identifies the customer to provide the comparison information, and causes the terminal device 300 to display the information corresponding to the identified customer.

When making a request for transmission of comparison information, the terminal device 300 may specify a customer instead of a store shelf, according to the store clerk's input operation. In this case, the product information providing apparatus 200 executes steps S33 to S39 for the specified customer. In this case, the terminal device 300 receives in advance information on customers from the product information providing apparatus 200 and displays the same. The store clerk refers to the displayed information on the customers, visually identifies a target customer to provide the comparison information, and then performs an operation of selecting the customer.

According to the product information providing system 3 in the second embodiment, the comparison information generation unit 230 generates comparison information based on data items each having different data values registered out of the product information on products attracting the interest of a customer. Accordingly, it is possible to identify information useful for the customer who considers purchase of a product, and provide the information for the operator of the terminal device 300.

Products viewed by a customer are determined as products attracting the interest of the customer. In general, a customer views products in which he/she has interest. Therefore, the above approach makes it possible to accurately identify the products attracting the interest of the customer and identify the information useful for the customer to select a product.

Comparison information is generated by extracting data items each having different data values between the product information on a most-viewed product and the product information on each of other products. Based on comparison between the product attracting the highest interest of the customer and the other products, the comparison information is more useful for the customer to select a product.

The most-viewed product is selected based on how long and how many times customer has viewed it. Accordingly, it is possible to accurately identify the product attracting the highest interest of the customer and accurately identify information useful for the customer to consider purchase of a product.

Further, it is determined, on the basis of a positional relation between a customer's wrist and a set area and the conditions of the set area, whether the customer has picked up or placed back a product, and then it is determined according to results of the determination whether the customer has started or ended viewing the product. Accordingly, it is possible to accurately determine whether the customer has viewed the product.

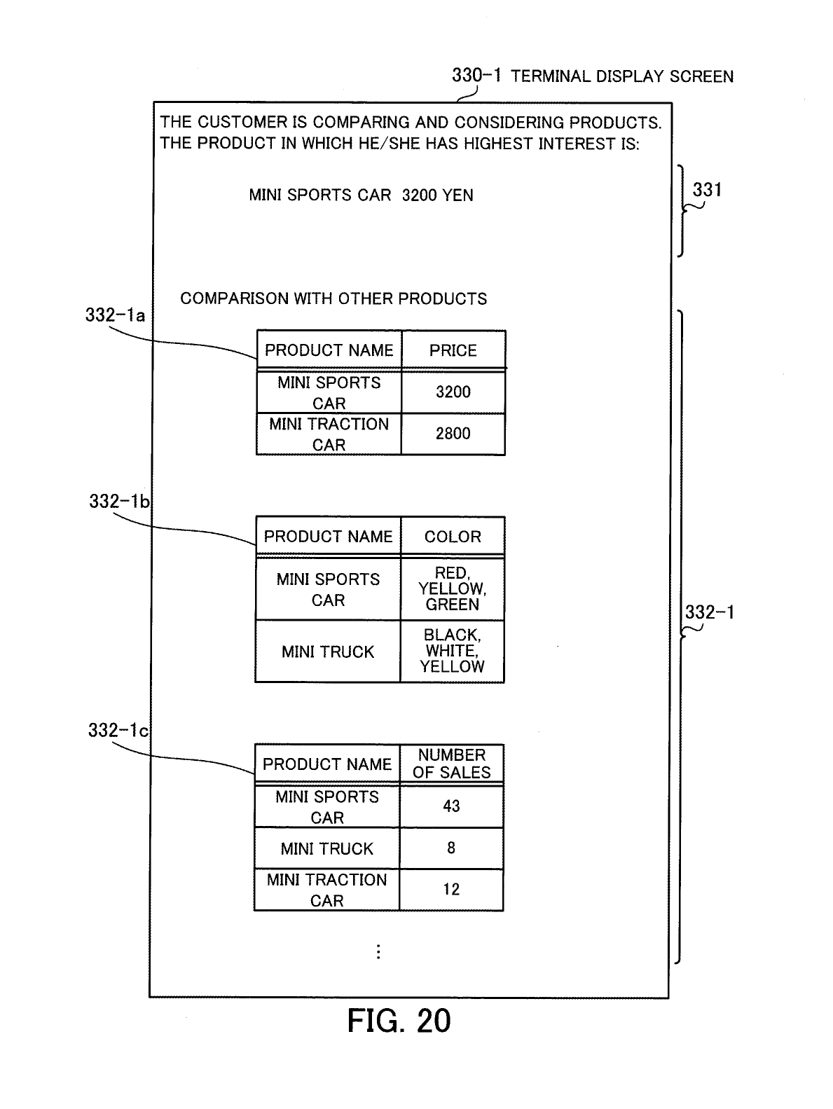

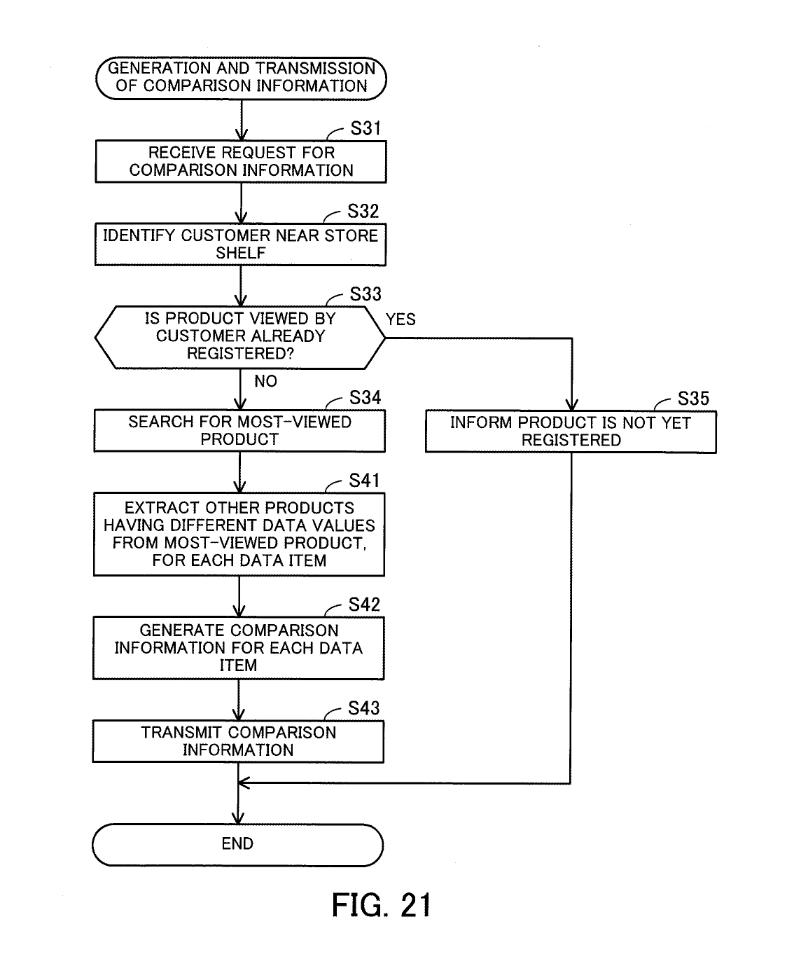

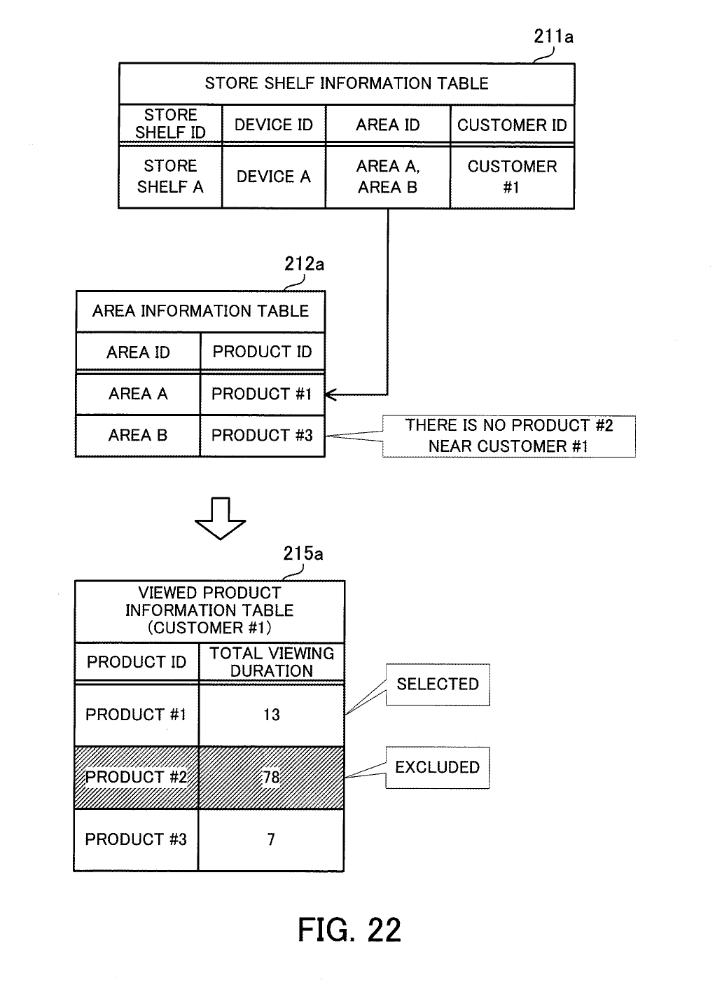

Next, modifications of the product information providing system 3 will be described with reference to FIGS. 20 to 22. First, referring to FIGS. 20 and 21, a modification of the contents of comparison information and a modification of a method for generating the comparison information will be described. Then, referring to FIG. 22, a modification of a method for identifying a most-viewed product will be described. In the following description with reference to FIGS. 20 to 22, only differences from the second embodiment will be explained and the same configurations and processes as those in the product information providing system 3 of the second embodiment will not be explained.

FIG. 20 illustrates a modification of the contents of comparison information and display of the same. A terminal display screen 330-1 has a product comparison display field 332-1 instead of the product comparison display field 332. The product comparison display field 332-1 presents comparison information 332-1a, 332-1b, and 332-1c. The comparison information 332-1a, 332-1b, and 332-1c is generated for each data item having different data values between a most-viewed product and other products, and indicates the different data values for comparison.

The product information providing apparatus 200 generates the comparison information 332-1a, 332-1b, and 332-1c in a manner as described below. First, the product information providing apparatus 200 detects, from all the products viewed by a customer other than the most-viewed product, products each having a different data value from the most-viewed product for each of the data items in the product information. Then, the product information providing apparatus 200 generates the comparison information 332-1a, 332-1b, and 332-1c containing the different data values registered in the respective data items on the most-viewed product and the detected other products, and transmits the same to the terminal device 300.

For example, as illustrated in FIG. 13, for the data item of price, “product #3” has a data value different from that of the most-viewed product “product #2”. For the data item of color, “product #1” has a data value different from that of the “product #2.” For the data item of number of sales, the “product #1” and “product #3” have data values different from that of the “product #2.” Accordingly, the comparison information 332-1a includes the data values registered in the data item of price with respect to the “product #2” and “product #3.” The comparison information 332-1b includes the data values registered in the data item of color with respect to the “product #2” and “product #1.” The comparison information 332-1c includes the data values registered in the data item of number of sales with respect to the “product #2,” “product #1,” and “product #3.”

The product information providing apparatus 200 may sort the data values registered on the other products in the comparison information in descending order of the total view count. Sorting the information allows the store clerk to easily recognize information on products attracting higher interest of the customer. The data values registered on the products in the comparison information may be sorted by the total viewing duration or any other data item with different data values as well as the total view count.

The product information providing apparatus 200 transmits the generated comparison information 332-1a, 332-1b, and 332-1c to the terminal device 300. Then, the comparison information 332-1a, 332-1b, and 332-1c is displayed on the terminal display screen 330-1 in the product comparison display field 332-1 as illustrated in FIG. 20.

FIG. 21 is a flowchart of a modification of a process for generating and transmitting comparison information. The modification is made to the second embodiment as steps S36 to S39 in FIG. 19 are replaced with steps S41 to S43 in FIG. 21. Steps S41 to S43 will be described below.

(S41) The comparison information generation unit 230 extracts products having data values different from that of a most-viewed product from all the products registered in the viewed product information table 215, for each of the data items in the product information table 213 (except for product ID).

(S42) The comparison information generation unit 230 generates comparison information for each of the data items. The comparison information generation unit 230 holds, in the generated comparison information for each of the data items, the product IDs of the most-viewed product and the other products having different registered data values in the data item, and the data values registered in the data item.

The comparison information generation unit 230 may sort the data values of the generated comparison information in descending order of the total view count. The comparison information generation unit 230 may sort the registered data values in descending order of the total viewing duration instead of the total view count.

(S43) The comparison information output unit 240 transmits the generated comparison information to the terminal device 300. As in step S39, the comparison information output unit 240 transmits the information indicative of the price and product name of the most-viewed product to the terminal device 300.

After that, the comparison information acquisition unit 310 receives the information on the price and product name of the most-viewed product and the comparison information. Then, the comparison information display unit 320 displays the received information on the price and product name of the most-viewed product in the most-viewed product display field 331 on the terminal display screen 330-1, and also displays the received comparison information in the product comparison display field 332-1 on the terminal display screen 330-1.

As described above with reference to FIGS. 20 and 21, according to the modification of the product information providing system 3, the comparison information is generated for each of the data items in the product information by extracting other products having different registered data values from the most-viewed product. In selecting a product, some customers may place importance on its price and others on appearance (color or the like). Accordingly, it is possible to finely identify information useful for the customer by extracting products having different data values registered in each of the data items and outputting the data values of the data items with respect to the extracted products in a comparable manner.

FIG. 22 illustrates a modification of a method for identifying a most-viewed product. In the modification of the product information providing system 3, the comparison information generation unit 230 of the product information providing apparatus 200 identifies a most-viewed product from products arranged in the store shelf near a customer, instead of identifying a most-viewed product from all the products viewed by the customer.

A store shelf information table 211a has a record with a store shelf ID of “store shelf A,” a device ID of “device A,” an area ID of “area A, area B,” and a customer ID of “customer #1.”

An area information table 212a has a record with an area ID of “area A” and a product ID of “product #1,” and a record with an area ID of “area B” and a product ID of “product #3.” The area information table 212a has no record with a product ID of “product #2.” The area information table 212a of FIG. 22 does not include any data items other than area ID and product ID.

A viewed product information table 215a has a record with a product ID of “product #1” and a total viewing duration of “13,” a record with a product ID of “product #2” and a total viewing duration of “78,” and a record with a product ID of “product #3” and a total viewing duration of “7.” The viewed product information table 215a of FIG. 22 does not include any data items other than product ID and total viewing duration.

For example, it is assumed that the customer identified as “customer #1” is located near the store shelf identified as “store shelf A.” It is also assumed that comparison information for the customer is desired to be displayed on the terminal device 300. In this case, the store clerk performs an input operation on the terminal device 300 to specify the “store shelf A.”

In the store shelf information table 211a, the area ID in the record with “store shelf A” includes “area A” and “area B.”. As is seen in the area information table 212a, the product ID corresponding to the “area A” is “product #1,” the product ID corresponding to the “area B” is “product #3,” and no area ID is registered corresponding to “product #2”. That is, the “product #2” is not arranged on the “store shelf A” near the “customer #1.”

Therefore, the comparison information generation unit 230 identifies, as a most-viewed product, a product registered in the record with the longest total viewing duration, out of all the records except for a record with “product #2” in the viewed product information table 215a, as illustrated in the lower part of FIG. 22. That is, the comparison information generation unit 230 identifies a record with the most-viewed product out of the records with “product #1” or “product #3.” As illustrated in the viewed product information table 215a, of the records with “product #1” or “product #3,” the product ID in a record with the longest total viewing duration (“13”) is “product #1.” Therefore, in FIG. 22, the “product #1” is identified as a most-viewed product.

By the foregoing process, a store clerk is able to recognize, through the terminal device 300, comparison information for comparison between product information on a product attracting the highest interest of a customer and product information on other products attracting the interest of the customer, out of all the products near the customer. This improves efficiency of the service store clerk offers to the customer. In addition, comparison is made between the most-viewed product and mainly the other products near the customer, which enables the store clerk to provide useful information for the customer.

As described above, the information processing in the first embodiment may be realized by causing the information processing apparatus 10 to execute programs, and the information processing in the second embodiment may be realized by causing the sensor devices 100a and 100b, the product information providing apparatus 200, and the terminal device 300 to execute programs. Such programs may be recorded in a computer-readable storage medium (for example, the storage medium 43). Such storage media include magnetic discs, optical discs, magneto-optical discs, semiconductor memories, and the like, for example. The magnetic discs include FDs or HDDs. The optical discs include CDs, CD-Rs (recordable), CD-RWs (rewritable), DVDs, DVD-Rs, and DVD-RWs.

For distribution of the programs, a portable storage medium on which the programs are recorded may be provided, for example. For instance, a computer stores in a recording device (for example, the HDD 203) the programs from the portable storage medium or the programs received from another computer, reads the programs from the recording device, and executes the same. Alternatively, the computer may execute the programs directly read from the portable storage medium. At least part of the foregoing information processing may be implemented by using a DSP (digital signal processing), ASIC, PLD (programmable logic device), or other electronic circuits.

In one aspect of the present invention, it is possible to identify information useful for a customer to select a product.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A product information providing method comprising:
extracting, by a computer, based on information indicating a plurality of products and registered information in which data values are registered in a plurality of data items for each of the plurality of products, a data item having possibly different data values between the plurality of products; and
outputting, by the computer, the data values registered in the extracted data item.

2. The product information providing method according to claim 1, wherein the extracting includes selecting a product from the plurality of products and extracting the data item having different data values between the selected product and other products of the plurality of products.

3. The product information providing method according to claim 2, wherein the outputting includes outputting the data values registered in the extracted data item for each of combinations of the selected product and the other products.

4. The product information providing method according to claim 3, wherein the outputting includes sorting data values corresponding to the other products included in said each combination, in descending order of values indicating degree of customer's interest, and outputting the data values for said each combination.

5. The product information providing method according to claim 2, wherein the outputting includes identifying, for each of the data items of the registered information, a product having a different data value from the selected product, registered in said each data item, and outputting the data values corresponding to the selected product and the identified product for said each data item.

6. The product information providing method according to claim 2, wherein the selected product is a product corresponding to a highest of values indicating degree of customer's interest, out of the plurality of products.

7. The product information providing method according to claim 2, wherein the selected product is a product arranged in an arrangement area nearest a customer, out of a plurality of arrangement areas where the plurality of products is arranged.

8. The product information providing method according to claim 1, wherein the plurality of products is products picked up by a customer, out of products arranged in a predetermined area.

9. A product information providing apparatus comprising:
a processor configured to perform a process including:
extracting, based on information indicating a plurality of products and registered information in which data values are registered in a plurality of data items for each of the plurality of products, a data item having possibly different data values between the plurality of products; and
outputting the data values registered in the extracted data item.

10. The product information providing apparatus according to claim 9, wherein the extracting includes selecting a product from the plurality of products and extracting the data item having different data values between the selected product and other products of the plurality of products.

11. The product information providing apparatus according to claim 10, wherein the outputting includes outputting the data values registered in the extracted data item for each of combinations of the selected product and the other products.

12. The product information providing apparatus according to claim 11, wherein the outputting includes sorting data values corresponding to the other products included in said each combination, in descending order of values indicating degree of customer's interest, and outputting the data values for said each combination.

13. The product information providing apparatus according to claim 10, wherein the outputting includes identifying, for each of the data items of the registered information, a product having a different data value from the selected product, registered in said each data item, and outputting the data values corresponding to the selected product and the identified product for each said data item.

14. The product information providing apparatus according to claim 10, wherein the selected product is a product corresponding to a highest of values indicating degree of customer's interest, out of the plurality of products.

15. The product information providing apparatus according to claim 10, wherein the selected product is a product arranged in an arrangement area nearest a customer, out of a plurality of arrangement areas where the plurality of products is arranged.

16. The product information providing apparatus according to claim 9, wherein the plurality of products is products picked up by a customer, out of products arranged in a predetermined area.

17. A non-transitory computer-readable storage medium storing a computer program that causes a computer to perform a process for providing product information, the process comprising:
extracting, based on information indicating a plurality of products and registered information in which data values are registered in a plurality of data items for each of the plurality of products, a data item having possibly different data values between the plurality of products; and
outputting the data values registered in the extracted data item.
